(19) United States
(12) Patent Application Publication
(10) Pub. No.: US 2026/0245576 A1
(43) Pub. Date: Aug. 20, 2026

(54) LYRIC FILE GENERATION METHOD AND APPARATUS

(71) Applicant: LEMON INC., GRAND CAYMAN (KY)

(72) Inventors: Junyu DAI, BEIJING (CN); Xuchen SONG, LOS ANGELES, CA (US); Qiuqiang KONG, BEIJING (CN); Yuxuan WANG, LOS ANGELES, CA (US)

(21) Appl. No.: 18/277,857

(22) PCT Filed: Feb. 18, 2022
(86) PCT No.: PCT/SG2022/050078

§ 371 Date: Aug. 18, 2023

(30) Foreign Application Priority Data
Feb. 19, 2021 (CN) 202110192245.9

(51) Int. Cl. G10L 25/48; G10L 15/02; G10L 25/18; G10L 25/24; G10L 25/30; G10L 25/81

(52) U.S. Cl. CPC G10L 25/48; G10L 15/02; G10L 25/18; G10L 25/24; G10L 25/30; G10L 25/81; G10L 2015/025

(57) ABSTRACT

This disclosure discloses a lyric file generation method and a lyric file generation apparatus, relating to the field of audio processing technology. The file generation method comprises: obtaining a phoneme propagation sequence of a song and an audio frame sequence of the song, the phoneme propagation sequence comprising a phoneme corresponding to a text unit in a lyric text of the song; determining an audio frame corresponding to the text unit in the audio frame sequence, wherein the phoneme corresponding to the text unit matches with an audio feature of the audio frames; determining time information of the text unit based on playback durations of the audio frame; and generating a lyric file of the song based on the time information of the text unit, wherein the lyric file is used to indicate a display of a text unit when the song is played to a location indicated by the time information of the text unit.

### CROSS-REFERENCE TO RELATED APPLICATIONS

The present disclosure is based on and claims priority of Chinese application for invention No. 202110192245.9, filed on Feb. 19, 2021, the disclosure of which is hereby incorporated into this disclosure by reference in its entirety.

### TECHNICAL FIELD

The present disclosure relates to the field of audio processing technology, in particular to a lyric file generation method and a lyric file generation apparatus.

### BACKGROUND

Songs as an art form are combinations of text and musical scores. Songs have become an indispensable form of public entertainment due to their ability to provide people with comprehensive listening enjoyment and to express human emotions.

At present, a great number of songs are created each day. For music playback platforms, in general, only the lyric text, not the lyric files are available for these explosive new songs. In order to obtain the lyric file of a song, it is necessary to obtain the display time of each character during the playback of the song. Based on both the display time of each character and the text, an applicable lyric file is generated on the playback platform, so that the text corresponding to the audio content can be displayed in real time during the playback of the song. At present, lyric files are mainly created manually in industrial application scenarios. That is, the lyric file of a song is generated by manually obtaining time information of each character contained in the audio outputted during the playback of the song, and manually setting the display time of each character in the text corresponding to the lyric file. However, this method of manually generating lyric files is time-consuming, labor-intensive, and extremely inefficient.

### SUMMARY

In a first aspect, an embodiment of the present disclosure provides a lyric file generation method, comprising:
obtaining a phoneme propagation sequence of a song and an audio frame sequence of the song, the phoneme propagation sequence comprising a phoneme corresponding to a text unit in a lyric text of the song;
determining an audio frame corresponding to the text unit in the audio frame sequence, wherein the phoneme corresponding to the text unit matches with an audio feature of the audio frame;
determining time information of the text unit based on playback duration of the audio frame; and
generating a lyric file of the song based on the time information of the text unit, wherein the lyric file is used to indicate a display of the text unit when the song is played to a location indicated by the time information.

As an optional embodiment of the present disclosure, the obtaining the phoneme propagation sequence of the song comprises:
obtaining a phoneme set corresponding to the text unit based on a pronunciation lexicon, wherein the pronunciation lexicon comprises a correspondence between the text unit and the phoneme set, and the phoneme set corresponding to the text unit is a set of phoneme(s) corresponding to pronunciation(s) of the text unit;
obtaining the phoneme corresponding to the text unit from the phoneme set corresponding to the text unit based on a pronunciation of the text unit in the song; and
generating the phoneme propagation sequence based on the phoneme corresponding to the text unit.

As an optional embodiment of the present disclosure, the obtaining the phoneme propagation sequence of the song comprises:
obtaining a phoneme set corresponding to the text unit based on a pronunciation lexicon, wherein the pronunciation lexicon comprises a correspondence between the text unit and the phoneme set, the phoneme set corresponding to the text unit being a set composed of phoneme subset(s) corresponding to pronunciation(s) of the text unit, and a phoneme subset corresponding to any of the pronunciation(s) being a set comprising permutation and combinations of various pronunciation durations of the phoneme(s) corresponding to the pronunciation;
obtaining a target phoneme subset of the text unit from the phoneme set corresponding to the text unit based on a pronunciation of the text unit in the song;
obtaining the phoneme corresponding to the text unit from the target phoneme subset of the text unit based on a pronunciation duration of the text unit in the song; and
generating the phoneme propagation sequence based on the phoneme corresponding to the text unit.

As an optional embodiment of the present disclosure, the obtaining the phoneme propagation sequence of the song comprises:
obtaining a phoneme set corresponding to the text unit based on a pronunciation lexicon, wherein the pronunciation lexicon comprises a correspondence between the text unit and the phoneme set, the phoneme set corresponding to the text unit being a set composed of phoneme subset(s) corresponding to pronunciation(s) of the text unit, and a phoneme subset corresponding to any of the pronunciation(s) being a set comprising permutation and combination of various phoneme(s) and various phoneme(s) with transposition phoneme corresponding to the pronunciation;
obtaining a target phoneme subset of the text unit from the phoneme set corresponding to the text unit based on a pronunciation thereof in the song;
obtaining the phoneme corresponding to the text unit from the target phoneme subset of the text unit based on a tone conversion of the text unit in the song; and
generating the phoneme propagation sequence based on the phoneme corresponding to the text unit.

As an optional embodiment of the present disclosure, the obtaining the audio frame sequence of the song comprises:
sampling audio signals of the song based on a preset sampling frequency and a preset format to obtain a sampling sequence of the song; and
generating the audio frame sequence of the song based on a duration of the audio frame and the sampling sequence.

As an optional embodiment of the present disclosure, the preset sampling frequency is 16 kHz; and
the preset format is a 16-bit mono Wave Pulse Code Modulation (PCM) format.

As an optional embodiment of the present disclosure, the method further comprises:
performing a Fourier transform on each audio frame in the audio frame sequence to obtain a Fourier transform spectrum for the each audio frame before determining the audio frames corresponding to the text units in the audio frame sequence;
separating a human voice spectrum from an accompaniment spectrum in the Fourier transform spectrum of the each audio frame to obtain a human voice spectrum of the each audio frame; and
converting the human voice spectrum of the each audio frame into a Mel Frequency Cepstrum Coefficient (MFCC) feature to obtain an audio feature of the each audio frame.

As an optional embodiment of the present disclosure, the determining the audio frame corresponding to the text unit in the audio frame sequence comprises:
obtaining matching relationships between audio features and phonemes in the phoneme propagation sequence based on a matching model, wherein the matching model is a model obtained by training a neural network model based on training samples comprising matched audio features and phonemes; and
determining the audio frame corresponding to the text unit in the audio frame sequence based on the matching relationships between various audio features and phonemes in the phoneme propagation sequence, as well as the phoneme corresponding to the text unit.

As an optional embodiment of the present disclosure, the obtaining the matching relationships between the various audio features and the phonemes in the phoneme propagation sequence based on the matching model comprises:
performing a Fourier transform on each audio frame in the audio frame sequence to obtain a Fourier transform spectrum for the each audio frame;
separating a human voice spectrum and an accompaniment spectrum in the Fourier transform spectrum of the each audio frame to obtain the accompaniment spectrum of the each audio frame;
obtaining a genre of the song based on the accompaniment spectrum of the each audio frame;
obtaining a target matching model, the target matching model being a matching model corresponding to the genre of the song; and
obtaining the matching relationships between the various audio features and the phonemes in the phoneme propagation sequence based on the target matching model.

As an optional embodiment of the present disclosure, the determining the time information of the text unit based on the playback duration of the audio frame comprises:
obtaining time information of the various phonemes in the phoneme propagation sequence based on playback durations of the audio frames and the matching relationships between the various phonemes in the phoneme propagation sequence and the audio features; and
determining the time information of the text unit based on the time information of the various phonemes in the phoneme propagation sequence and the phoneme corresponding to the text unit.

As an optional embodiment of the present disclosure, the time information of each phoneme of the phonemes in the phoneme propagation sequence comprises a start time and a duration of the each phoneme; and
the time information of the text unit comprises a start time and a duration of the text unit.

As an optional embodiment of the present disclosure, the method further comprises:
obtaining a confidence sequence, wherein various confidence scores in the confidence sequence are used to represent matching degrees between the audio features and the phonemes;
determining whether the matching degrees between the phonemes and the audio features corresponding to the text unit are all less than a preset threshold based on the confidence sequence; and
in a case where the matching degrees of the phonemes and the audio features corresponding to a text unit are all less than the preset threshold value, adjusting the start times of all the text units after the text unit in the lyrics text forward by a preset time length.

As an optional embodiment of the present disclosure, the preset time length is 0.3 seconds.

As an optional embodiment of the present disclosure, the neural network model comprises a preprocessing layer, a convolution layer, a time delay neural network (TDNN) layer, and a classification output layer in sequence;
the preprocessing layer comprises a Fully Connected Layer for upsampling the audio features in the training samples;
the convolution layer comprises two layers of convolution neural networks (CNN), each of which comprises: a sub-convolution layer, an activation layer and a batch normalization (BN) layer;
the TDNN layer comprises ten layers of TDNN; and
the classification output layer comprises: a BN layer and a Fully Connected Layer for matching an output result of the TDNN layer with various phonemes in a phoneme propagation sequence in the training samples after downsampling the output result.

As an optional embodiment of the present disclosure, among the ten layers of TDNN in the TDNN layer, two layers of TDNN with an interval of 0 or 1 or 3 are interconnected.

In a second aspect, an embodiment of the present disclosure provides a lyric file generation apparatus, comprising:
a feature acquisition unit for obtaining a phoneme propagation sequence of a song and an audio frame sequence of the song, the phoneme propagation sequence comprising a phoneme corresponding to a text unit in a lyric text of the song;
a matching unit for determining an audio frame corresponding to the text unit in the audio frame sequence, wherein the phoneme corresponding to the text unit matches with an audio feature of the audio frame;
a time information acquisition unit for determining time information of the text unit based on a playback duration of the audio frame; and
a generation unit for generating a lyric file of the song based on the time information of the text unit, wherein the lyric file is used to indicate a display of the text unit when the song is played to a location indicated by the time information.

As an optional embodiment of the present disclosure, the feature acquisition unit is specifically used for obtaining a phoneme set corresponding to the text unit based on a pronunciation lexicon, wherein the pronunciation lexicon comprises a correspondence between the text unit and the phoneme set, and the phoneme set corresponding to the text unit is a set of phoneme(s) corresponding to pronunciation(s) of the text unit; obtaining the phoneme corresponding to the text unit from the phoneme set corresponding to the text unit based on a pronunciation of the text unit in the song; and generating the phoneme propagation sequence based on the phoneme corresponding to the text unit.

As an optional embodiment of the present disclosure, the feature acquisition unit is specifically used for obtaining a phoneme set corresponding to the text unit based on a pronunciation lexicon, wherein the pronunciation lexicon comprises correspondence between the text unit and the phoneme set, the phoneme set corresponding to the text unit being a set composed of phoneme subset(s) corresponding to pronunciation(s) of the text unit, and a phoneme subset corresponding to any of the pronunciation(s) being a set comprising permutation and combinations of various pronunciation durations of the phoneme(s) corresponding to the pronunciation; obtaining a target phoneme subset of the text unit from the phoneme set corresponding to the text unit based on a pronunciation of the text unit in the song; obtaining the phoneme corresponding to the text unit from the target phoneme subset of the text unit based on a pronunciation duration of the text unit in the song; and generating the phoneme propagation sequence based on the phoneme corresponding to the text unit.

As an optional embodiment of the present disclosure, the feature acquisition unit is specifically used for obtaining a phoneme set corresponding to the text unit based on a pronunciation lexicon, wherein the pronunciation lexicon comprises a correspondence between the text unit and the phoneme set, the phoneme set corresponding to the text unit being a set composed of phoneme subset(s) corresponding to pronunciation(s) of the text unit, and a phoneme subset corresponding to any of the pronunciation(s) being a set comprising permutation and combination of various phoneme(s) and various phoneme(s) with transposition phoneme corresponding to the pronunciation; obtaining a target phoneme subset of the text unit from the phoneme set corresponding to the text unit based on a pronunciation thereof in the song; obtaining the phoneme corresponding to the text unit from the target phoneme subset of the text unit based on a tone conversion of the text unit in the song; and generating the phoneme propagation sequence based on the phoneme corresponding to the text unit.

As an optional embodiment of the present disclosure, the feature acquisition unit is specifically used for sampling audio signals of the song based on a preset sampling frequency and a preset format to obtain a sampling sequence of the song; and generating the audio frame sequence of the song based on a duration of the audio frame and the sampling sequence.

As an optional embodiment of the present disclosure, the preset sampling frequency is 16 kHz; and
the preset format is a 16-bit mono Wave Pulse Code Modulation (PCM) format.

As an optional embodiment of the present disclosure, the matching unit is specifically used for performing a Fourier transform on each audio frame in the audio frame sequence to obtain a Fourier transform spectrum for the each audio frame before determining the audio frames corresponding to the text units in the audio frame sequence; separating a human voice spectrum from an accompaniment spectrum in the Fourier transform spectrum of the each audio frame to obtain a human voice spectrum of the each audio frame; and converting the human voice spectrum of the each audio frame into a Mel Frequency Cepstrum Coefficient (MFCC) feature to obtain an audio feature of the each audio frame.

As an optional embodiment of the present disclosure, the matching unit is further used for obtaining matching relationships between audio features and phonemes in the phoneme propagation sequence based on a matching model, wherein the matching model is a model obtained by training a neural network model based on training samples comprising matched audio features and phonemes; and determining the audio frame corresponding to the text unit in the audio frame sequence based on the matching relationships between various audio features and phonemes in the phoneme propagation sequence, as well as the phoneme corresponding to the text unit.

As an optional embodiment of the present disclosure, the time information acquisition unit is used for obtaining time information of the various phonemes in the phoneme propagation sequence based on playback durations of the audio frames and the matching relationships between the various phonemes in the phoneme propagation sequence and the audio features; and determining the time information of the text unit based on the time information of the various phonemes in the phoneme propagation sequence and the phoneme corresponding to the text unit.

As an optional embodiment of the present disclosure, the time information of each phoneme of the phonemes in the phoneme propagation sequence comprises a start time and a duration of the each phoneme; and
the time information of the text unit comprises a start time and a duration of the text unit.

As an optional embodiment of the present disclosure, the generation unit is further used for obtaining a confidence sequence, wherein various confidence scores in the confidence sequence are used to represent matching degrees between the audio features and the phonemes; determining whether the matching degrees between the phonemes and the audio features corresponding to the text unit are all less than a preset threshold based on the confidence sequence; and in a case where the matching degrees of the phonemes and the audio features corresponding to a text unit are all less than the preset threshold value, adjusting the start times of all the text units after the text unit in the lyrics text forward by a preset time length.

As an optional embodiment of the present disclosure, the preset time length is 0.3 seconds.

As an optional embodiment of the present disclosure, the neural network model comprises a preprocessing layer, a convolution layer, a time delay neural network (TDNN) layer, and a classification output layer in sequence; the preprocessing layer comprises a Fully Connected Layer for upsampling the audio features in the training samples; the convolution layer comprises two layers of convolution neural networks (CNN), each of which comprises: a sub-convolution layer, an activation layer and a batch normalization (BN) layer; the TDNN layer comprises ten layers of TDNN; and the classification output layer comprises: a BN layer and a Fully Connected Layer for matching an output result of the TDNN layer with various phonemes in a phoneme propagation sequence in the training samples after downsampling the output result.

As an optional embodiment of the present disclosure, among the ten layers of TDNN in the TDNN layer, two layers of TDNN with an interval of 0 or 1 or 3 are interconnected.

In a third aspect, an embodiment of the present disclosure provides an electronic device, comprising: a memory for storing computer programs; a processor for performing, by invoking the computer programs, the lyric file generation method of any one of the optional embodiments according to the first or second aspect of the present disclosure.

In a fourth aspect, an embodiment of the present disclosure provides a computer-readable medium having stored thereon a computer program that, when executed by a processor, implements the lyric file generation method of any one of the optional embodiments according to the first or second aspect of the present disclosure.

In a fifth aspect, an embodiment of the present disclosure provides a computer program, comprising: instructions that, when executed by a processor, cause the processor to perform any one of the lyric file generation methods described above.

In a sixth aspect, an embodiment of the present disclosure provides a computer program product comprising instructions that, when executed by a processor, cause the processor to perform any one of the lyric file generation methods described above.

### BRIEF DESCRIPTION OF THE DRAWINGS

Herein, the accompanying drawings, which are incorporated in and constitute a part of this specification, illustrate embodiments of the present disclosure and, together with the description, serve to explain the principles of the present disclosure.

In order to more clearly explain the embodiments of the present invention or the technical solutions in the prior art, a brief introduction will be given below for the drawings required to be used in the description of the embodiments or the prior art. It is obvious that, for a person skilled in the art, he or she may also acquire other drawings according to such drawings on the premise that no inventive effort is involved.

FIG. 1 is a first flowchart of a lyric file generation method provided in an embodiment of the present disclosure;

FIG. 2 is a first schematic diagram showing a pronunciation lexicon provided in an embodiment of the present disclosure;

FIG. 3 is a second schematic diagram of a pronunciation lexicon provided in the embodiment of the present disclosure;

FIG. 4 is a third schematic diagram of a pronunciation lexicon provided in the embodiment of the present disclosure;

FIG. 5 is a fourth schematic diagram of a pronunciation lexicon provided in the embodiment of the present disclosure;

FIG. 6 is a schematic diagram showing a correspondence between phonemes and audio features provided in an embodiment of the present disclosure;

FIG. 7 is a schematic diagram showing a structure of a time delay neural network layer provided in an embodiment of the present disclosure;

FIG. 8 is a second flowchart of the lyric file generation method provided in the embodiment of the present disclosure;

FIG. 9 is a third flowchart of the lyric file generation method provided in the embodiment of the present disclosure;

FIG. 10 is a schematic diagram showing a structure of a lyric file generation apparatus provided in an embodiment of the present disclosure;

FIG. 11 is a schematic structural diagram of an electronic device provided in an embodiment of the present disclosure.

### DETAILED DESCRIPTION

In order to better understand the above objects, features and advantages of the present disclosure, the scheme of the present disclosure will be further described below. It should be noted that, in the case of no conflict, the embodiments and the features of the embodiments of the present disclosure may be combined with each other.

Many specific details are set forth in the following description to facilitate a full understanding of the present disclosure, but the present disclosure can also be implemented in other ways different from those described herein. Obviously, embodiments described in the description are only some embodiments of the present disclosure, and are not all of embodiments thereof.

The terms “first”, “second” and the like in the description and claims of the present disclosure are used to distinguish synchronized objects, and are not necessarily used to describe a specific sequence. For example, first and second operations are used to distinguish different operations, rather than describing the specific order of the operations.

In the present disclosed embodiment, words such as “as an illustration” or “for example” are used to provide examples, illustrations, or explanations. Any embodiments or designs described with “as an illustration” or “for example” in the embodiments of the present disclosure should not be construed as being more preferred or advantageous than other embodiments or designs. In particular, the use of words such as “as an illustration” or “for example” is intended to present relevant concepts in a specific way. Moreover, in the description of the embodiments of the present disclosure, unless otherwise indicated, the phrase “a plurality of” means “two or more”.

This disclosure provides a method and an apparatus for generating lyric files to address a problem of low efficiency in generating of lyric files in the prior art.

The executive subject of the lyric file generation method provided in the embodiment of the present disclosure may be a lyric file generation apparatus. The lyric file generation apparatus may be a terminal device, such as a mobile phone, a tablet computer, a laptop, an ultra mobile personal computer (UMPC), a netbook, a personal digital assistant (PDA), a smart watch, or a smart bracelet. The terminal device may also be other types of terminal devices, and the type of the terminal device is not limited in the embodiments of the present disclosure.

An embodiment of the present disclosure provides a lyric file generation method. As shown in FIG. 1, the lyric file generation method comprises steps S11 to S15.

In S11, a phoneme propagation sequence of a song and an audio frame sequence of the song are obtained.

The phoneme propagation sequence comprises phoneme(s) corresponding to text units in a lyric text of the song.

The lyric text in the embodiment of the present disclosure refers to text information corresponding to the vocal content of the song, which does not comprise a title or an author of the song, or time information of the text units, i.e., characters in the lyric text.

It should be noted that in the disclosed embodiment, phoneme(s) corresponding to a text unit may only comprise one phoneme or multiple phonemes. For example, a phoneme corresponding to a text unit which is a Chinese character with a pronunciation of “ai” only comprises one phoneme “ai_4”. For another example, phonemes corresponding to a text unit which is a Chinese character with a pronunciation of “xin” comprise two phonemes, namely “x” and “in_1”. As a further example, phonemes corresponding to a text unit which is a Chinese character with a pronunciation of “zhuang” comprise three phonemes, namely “zh”, “u”, and “ang_1”.

The way of obtaining the phoneme propagation sequence of the song in the above step S11 will be described in detail below.

### Implementation Method 1

The process of the obtaining the phoneme propagation sequence of the song in the above step S11 may comprise the following steps 111 to 113.

In step 111, a phoneme set corresponding to a text unit is obtained based on a pronunciation lexicon.

The pronunciation lexicon comprises a correspondence between the text unit and the phoneme set, wherein the phoneme set corresponding to the text unit is a set of phoneme(s) corresponding to pronunciation(s) of the text unit.

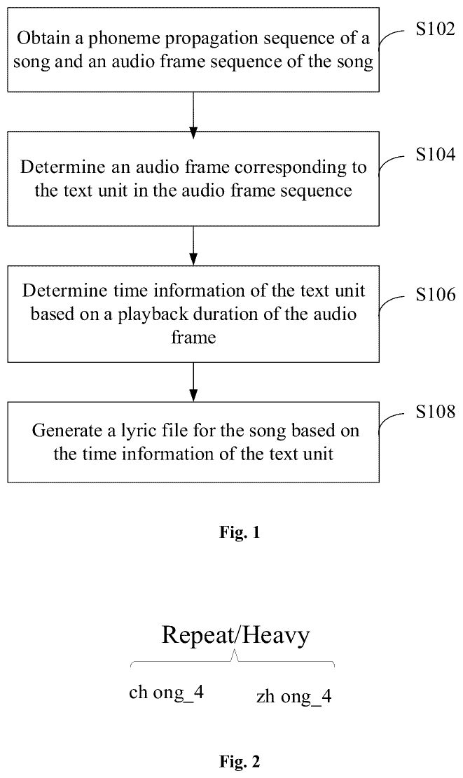

As an illustration, as shown in FIG. 2, the implementation process of step 111 above will be explained using a Chinese character with both pronunciations of “zhong” and “chong” and with both meanings of “Repeat” and “Heavy” as an example. As shown in FIG. 2, a phoneme set corresponding to the Chinese character is a set consisting of phonemes “zh ong_4” corresponding to the pronunciation “zhong” and phonemes “ch ong_4” corresponding to the pronunciation “chong”. Therefore, for this Chinese character in the lyric text, the phoneme set shown in FIG. 2 can be obtained based on the pronunciation lexicon.

In step 112, a phoneme corresponding to the text unit are obtained from the phoneme set corresponding to the text unit based on a pronunciation of the text unit in the song.

As mentioned in the above example, the phoneme set corresponding to the Chinese character is shown in FIG. 2. This Chinese character is pronounced as “chong” in a song pronounced as “chong tou zai lai” (start over), and therefore, the phonemes corresponding to this Chinese character can be determined as “zh ong_4” based on the phoneme set corresponding to this Chinese character as shown in FIG. 2.

In step 113, the phoneme propagation sequence is generated based on the phoneme corresponding to the text unit.

As an illustration, the above step 113 will be described below with an example that the lyric text is a Chinese text pronounced as “chong tou zai lai”, the phonemes of the first character in the lyric text are “ch ong_4”, the phonemes of the second character in the lyric text are “t ou_2”, the phonemes of the third character in the lyric text are “z ai_4”, and the phonemes of the fourth character in the lyric text are “l ai_2”. A phoneme propagation sequence generated based on the phonemes corresponding to the text units is: ch>ong_4>t>ou_2>z>ai_4>l>ai_2.

### Implementation Method 2

The process of the obtaining the phoneme propagation sequence of the song in the above step S11 may comprise the following steps 121 to 124.

In step 121, a phoneme set corresponding to the text unit is obtained based on a pronunciation lexicon.

The pronunciation lexicon comprises a correspondence between the text unit and the phoneme set, the phoneme set corresponding to the text unit being a set composed of phoneme subset(s) corresponding to pronunciation(s) of the text unit, and a phoneme subset corresponding to any of the pronunciation(s) being a set comprising permutation and combinations of various pronunciation durations of the phoneme(s) corresponding to the pronunciation.

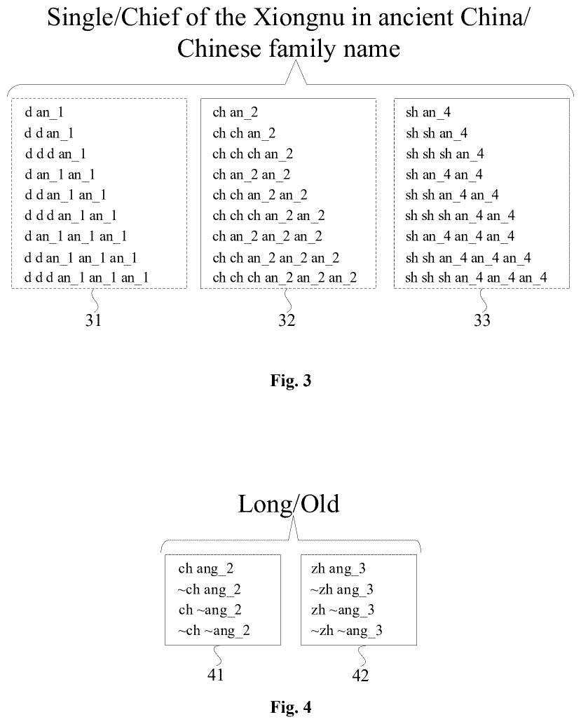

As an illustration, an implementation process of step 121 above will be explained with an example that pronunciation durations comprise three pronunciation durations. Chinese character with the meanings of “single”, “Chief of the Xiongnu in ancient China” and “a Chinese family name” shown in FIG. 3 has three pronunciations, namely “dan”, “chan”, and “shan”. Phonemes corresponding to the pronunciation “dan” are “d an_1”, phonemes corresponding to the pronunciation “chan” are “d an_2”, and phonemes corresponding to the pronunciation “shan” are “sh an 4”. Therefore, as shown in FIG. 3, the phoneme set corresponding to the Chinese character is a set composed of a phoneme subset 31 corresponding to the pronunciation “dan”, a phoneme subset 32 corresponding to the pronunciation “chan”, and a phoneme subset 33 corresponding to the pronunciation “shan”. The phoneme subset 31 corresponding to the pronunciation “dan” is a set composed of phonemes “d an_1”, “d d an_1”, “d d d an_1”, “d an_1 an_1”, “d d an_1 an_1”, “d d d an_1 an_1”, “d an_1 an_1 an_1”, “d d an_1 an_1 an_1”, and “d d d an_1 an_1 an_1”. The phoneme subset 32 corresponding to the pronunciation “chan” is a set composed of phonemes “ch an_2”, “ch ch an_2”, “ch ch ch an_2”, “ch an_2 an_2”,“ch ch an_2 an_2”, “ch ch ch an_2 an_2”, “ch an_2 an_2 an_2”, “ch ch an_2 an_2 an_2”, and “ch ch ch an_2 an_2 an_2”. The phoneme subset 33 corresponding to the pronunciation “shan” is a set composed of phonemes “sh an_4”, “sh sh an_4”, “sh sh sh an_4”, “sh an_4 an_4”, “sh sh an_4 an_4”, “sh sh sh an_4 an_4”, “sh an_4 an_4 an_4”, “sh sh an_4 an_4 an_4”, and “sh sh sh an_4 an_4 an_4”. A number of phonemes is used to indicate a pronunciation duration of the phoneme. For example, “d”, “d d” and “d d d” indicate that the pronunciation duration of the phoneme “d” belongs to a first pronunciation duration range, a second pronunciation duration range, and a third pronunciation duration range, respectively. For the Chinese character as shown in FIG. 3 in the lyric text, the phoneme set shown in FIG. 3 can be obtained based on the pronunciation lexicon.

In step 122, a target phoneme subset of the text unit is obtained from the phoneme set corresponding to the text unit based on its pronunciation in the song.

As mentioned in the above example, the phoneme set corresponding to the Chinese character with the meanings shown in FIG. 3 is shown in FIG. 3. The Chinese character is pronounced as “dan” in a song pronounced as “jian dan ai” (simple love), and therefore, from the phoneme set shown in FIG. 3, the target phoneme subset of the Chinese character can be determined as the phoneme subset 31 corresponding to the pronunciation “dan”.

In step 123, the phoneme corresponding to the text unit are obtained from the target phoneme subset of the text unit based on a pronunciation duration of the text unit in the song.

As mentioned in the example above, the target phoneme subset of the Chinese character with the meanings as shown in FIG. 3 is the phoneme subset 31 corresponding to the pronunciation “dan” in FIG. 3. Among the phonemes corresponding to the Chinese character, the phoneme “d” has a pronunciation duration belonging to the first pronunciation duration range in the song, and the phoneme “an_1” has a pronunciation duration belonging to the third pronunciation duration range in the song. Therefore, it is determined that the phonemes “d an_1 an_1 an_1” in the phoneme subset 31 corresponding to the pronunciation “dan” are the phonemes corresponding to the Chinese character.

In step 124, the phoneme propagation sequence is generated based on the phoneme corresponding to the text unit.

As an illustration, the step S125 will be described below with an example of a lyric text pronounced as “jian dan ai”, phonemes corresponding to the first character in the lyric text are “j an_3”, phonemes corresponding to the second character in the lyric text are “d an_1 an_1 an_1”, and phonemes corresponding to the third character in the lyric text are “ai_4 ai_4”. The phoneme propagation sequence generated based on the corresponding phonemes of each text unit is j>an_>>d>an_1>an_1>an_1>ai_4>ai_4.

### Implementation Method 3

The process of the obtaining the phoneme propagation sequence of the song in the above step S11 may comprise the following steps 131 to 134.

In step 131, a phoneme set corresponding to the text unit is obtained based on a pronunciation lexicon.

The pronunciation lexicon comprises correspondences between the text unit and the phoneme set, the phoneme set corresponding to the text unit being a set composed of phoneme subset(s) corresponding to pronunciation(s) of the text unit, and a phoneme subset corresponding to any of the pronunciation(s) being a set comprising permutation and combination of various phoneme(s) and various phoneme(s) with transposition phoneme corresponding to the pronunciation.

By way of example, as shown in FIG. 4, the implementation process of step 131 above will be explained using a Chinese character with both of the meanings “Long” and “Old” shown in FIG. 4 as an example. As shown in FIG. 4, a phoneme set corresponding to the Chinese character is a set composed of a phoneme subset 41 corresponding to a pronunciation “chang” and a phoneme subset 42 corresponding to a pronunciation “zhang”. The phoneme subset 31 corresponding to the pronunciation “chang” is a set consisting of phonemes “ch ang_2”, “~ch ang_2”, “ch~ang_2”, and “~ch~ang_2”. The phoneme subset 42 corresponding to the pronunciation “zhang” is a set consisting of phonemes “zh ang_2”, “~zh ang_2”, “zh ~ang_2”, and “~zh ~ang_2”. A symbol “~xx” is used to represent a transposition phoneme of a phoneme “xx”. For example, “~ang_2” represents a transposition phoneme of “ang_2”.

In step 132, a target phoneme subset of the text unit is obtained from the phoneme set corresponding to the text unit based on its pronunciation in the song.

As mentioned in the above example, the phoneme set corresponding to the Chinese character with both of the meanings “Long” and “Old” in FIG. 4 is shown in FIG. 4. The pronunciation of the Chinese character in a song “tian chang di jiu” (everlasting) is “chang”. Therefore, from the phoneme set shown in FIG. 4, the target phoneme subset of the Chinese character can be determined as the phoneme subset 41 corresponding to the pronunciation “chang”.

In step 133, the phoneme corresponding to the text unit is obtained from the target phoneme subset of the text unit based on a tone conversion of the text unit in the song.

As mentioned in the example above, the target phoneme subset of the Chinese character with both of the meanings “Long” and “Old” shown in FIG. 4 is the phoneme subset 41 corresponding to the pronunciation “chang” in FIG. 4. Among the phonemes corresponding to the Chinese character, the phoneme “ch” does not have tone conversion and the phoneme “ang_2” has tone conversion in the song. Therefore, it is determined that the phonemes “ch ~ang_2” in the phoneme subset 41 corresponding to the pronunciation “chang” are the phonemes corresponding to the Chinese character.

In step 134, the phoneme propagation sequence is generated based on the phoneme corresponding to the text unit.

As an illustration, the step 134 will be described below with an example that the lyric text is pronounced as “tian chang di jiu”, phonemes of the first character in the lyric text are “t an_1”, phonemes of the second character in the lyric text are “ch ~ang_2”, phonemes of the third character in the lyric text are “d i_4”, and phonemes of the fourth character in the lyric text are “j ~iu_3”. The phoneme propagation sequence generated based on the corresponding phonemes of each text unit is t>an_1>ch>~ang_2>d>i_4>j>~iu_3.

### Implementation Method 4

The process of the obtaining the phoneme propagation sequence of the song in the above step S11 may comprise the following steps 141 to 144.

In step 141, a phoneme set corresponding to the text unit is obtained based on a pronunciation lexicon.

The pronunciation lexicon comprises a correspondence between the text unit and the phoneme set, the phoneme set corresponding to the text unit being a set composed of phoneme subset(s) corresponding to pronunciation(s) of the text unit, and a phoneme subset corresponding to any pronunciation of the pronunciation(s) being a set comprising permutation and combination of various pronunciation pronunciation(s) of various phoneme(s) and various pronunciation pronunciation(s) of various phoneme(s) with transposition phoneme corresponding to the pronunciation.

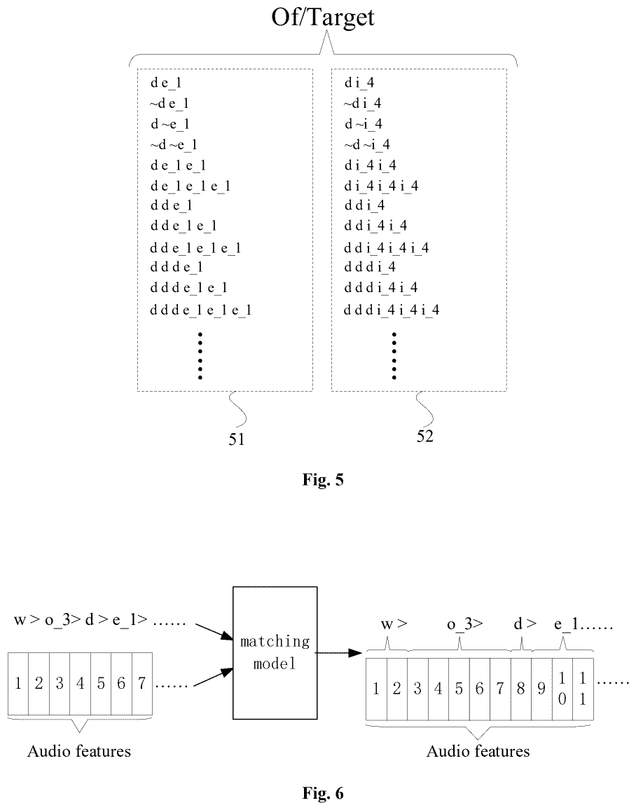

As an illustration, as shown in FIG. 5, a implementation process of step 141 above will be explained using a Chinese character with both of the meanings “of” and “target” shown in FIG. 5 as an example. As shown in FIG. 5, the phoneme set corresponding to the Chinese character is a set composed of a phoneme subset 51 corresponding to a pronunciation “de” and a phoneme subset 52 corresponding to a pronunciation “di”. The phoneme subset 51 corresponding to the pronunciation “de” is a set consisting of phonemes “d e_1”, “~d e_1”, “d~e_1”, “~~e_1”, “d e_1 e_1”, “d e_1 e_1 e_1” etc. The phoneme subset 52 corresponding to the pronunciation “di” is a set consisting of phonemes “d i_4”, “~d i_4”, “d ~i_4”, “~~i_4”, “d i_4 i_4”, “d i_4 i_4 i_4” etc.

In step 142, a target phoneme subset of the text unit is obtained from the phoneme set corresponding to the text unit based on its pronunciation in the song.

As mentioned in the above example, the phoneme set corresponding to the Chinese character with both of the meanings “of” and “target” shown in FIG. 5 is shown in FIG. 5. The Chinese character is pronounced as “de” in a lyric text pronounced as “wo de xin” (my heart) in a song, and therefore, from the phoneme set shown in FIG. 5, the target phoneme subset of the Chinese character can be determined as the phoneme subset 51 corresponding to the pronunciation “de”.

In step 143, the phoneme corresponding to the text unit is obtained from the target phoneme subset of the text unit based on a pronunciation duration and a tone conversion of the text unit in the song.

As mentioned in the example above, the target phoneme subset of the Chinese character with both of the meanings “of” and “target” shown in FIG. 5 is the phoneme subset 51 corresponding to the pronunciation “de” in FIG. 5. Among the phonemes corresponding to the Chinese character, the phoneme “d” does not have a tone conversion and has a pronunciation duration belonging to the first pronunciation duration range in the song, and the phoneme “e_1” has a pronunciation duration belonging to the second pronunciation duration range and has tone conversion in the song. Therefore, it is determined that the phonemes “d e_1~e_1” in the phoneme subset 51 corresponding to the pronunciation “de” are the phonemes corresponding to the Chinese character.

In step 144, the phoneme propagation sequence is generated based on the phoneme corresponding to the text unit.

As an illustration, the step S144 will be described below with an example that the lyric text is pronounced as “wo de xin”, phonemes corresponding to the first character in the lyric text are “w o_3”, phonemes corresponding to the second character in the lyric text are “d e_1~e_1”, and phonemes corresponding to the third character in the lyric text are “x in_4~in_4~in_4”. The three text units in the lyric text are sequentially pronounced. Therefore, the phoneme propagation sequence generated based on the corresponding phonemes of each text unit is: w>_>>d>e_1>~e_1>x>in_4>>in_4>~in_4.

The way of obtaining a phoneme propagation sequence of a song in the above step S11 will be described in detail below.

Optionally, the process of the obtaining the audio frame sequence of the song in step S11 above comprises:
sampling audio signals of the song based on a preset sampling frequency and a preset format to obtain a sampling sequence of the song; and
generating the audio frame sequence of the song based on a duration of the audio frame and the sampling sequence.

Optionally, the preset sampling frequency is 16 kHz; and
the preset format is a 16-bit mono Wave Pulse Code Modulation (PCM) format.

As an illustration, if a preset sampling frequency is 16 kHz and a duration of an audio frame is 25 ms, 16000 samples can be obtained per second, i.e., 400 sampling are performed for each audio frame (25 ms). Therefore, an audio frame sequence can be generated for the song, using each 400 sampling items in the sampling sequence as an audio frame, and arranging the audio frames in the order of their sampling data in the sampling sequence.

The process of the obtaining the audio frame sequence in the lyric file generation method provided in the embodiment of the present disclosure comprises: sampling audio signals of the song based on a preset sampling frequency and a preset format to obtain a sampling sequence of the song; then generating the audio frame sequence of the song based on the duration of the audio frame and the sampling sequence. Therefore, the lyric file generation method provided in the embodiment of the present disclosure is applicable to songs in any audio formats, thereby improving the applicability of the lyric file generation method provided by the present disclosure.

In S12, an audio frame corresponding to the text unit in the audio frame sequence are determined.

The phoneme corresponding to the text unit matches with an audio feature of the audio frame.

Optionally, before the determining the audio frame corresponding to the text unit in the audio frame sequence, the method further comprises:
performing a Fourier transform on each audio frame in the audio frame sequence to obtain a Fourier transform spectrum for the each audio frame;
separating a human voice spectrum from an accompaniment spectrum in the Fourier transform spectrum of the each audio frame to obtain a human voice spectrum of the each audio frame; and
converting the human voice spectrum of the each audio frame into a Mel Frequency Cepstrum Coefficient (MFCC) feature to obtain an audio feature of the each audio frame.

Optionally, the determining the audio frame corresponding to the text unit in the audio frame sequence comprises:
obtaining matching relationships between the audio features and the phonemes in the phoneme propagation sequence based on a matching model, wherein the matching model is a model obtained by training a neural network model based on training samples comprising matched audio features and phonemes; and
determining the audio frame corresponding to the text unit in the audio frame sequence based on the matching relationships between the various audio features and the phonemes in the phoneme propagation sequence, as well as the phonemes corresponding to the text units.

As an illustration, the matching relationships between the audio features and the phonemes in the phoneme propagation sequence may be shown in FIG. 6. Each of the audio features matches with a phoneme in the phoneme propagation sequence, and each phoneme in the phoneme propagation sequence may have one or more matched audio features.

Specifically, phoneme propagation sequences and audio features used for training can be obtained in the same or similar manner as in steps S11 and S12 described above, and matched audio features and phonemes can be manually or automatically annotated to obtain the training samples.

Optionally, the neural network model comprises a preprocessing layer, a convolution layer, a time delay neural network (TDNN) layer, and a classification output layer in sequence;
the preprocessing layer comprises a Fully Connected Layer for upsampling the audio features in the training samples;
the convolution layer comprises two layers of convolution neural networks (CNN), each of which comprises: a sub-convolution layer, an activation layer and a batch normalization (BN) layer;
the TDNN layer comprises ten layers of TDNN;
the classification output layer comprises: a BN layer and a Fully Connected Layer for matching an output result of the TONN layer with various phonemes in a phoneme propagation sequence in the training samples after downsampling the output result.

By upsampling the audio features in the training samples through the preprocessing layer, the features can be modeled at a finer granularity, thereby improving an accuracy of an output of the matching model.

Optionally, the activation layer is a Rectified Linear Unit (ReLU) layer, and each layer of the two layers of CNNs has a 3*3 convolution kernel.

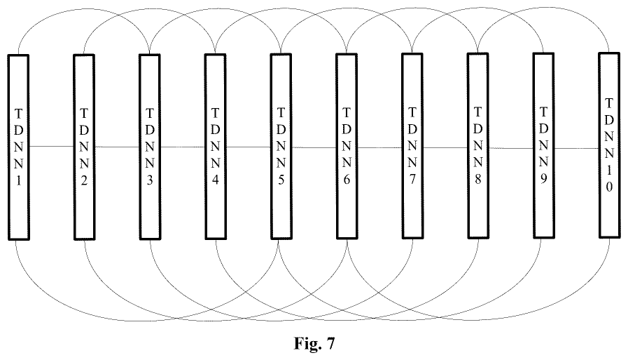

Optionally, as shown in FIG. 7, among the ten layers of TDNN in the TDNN layer, two layers of TDNN with an interval of 0 or 1 or 3 are interconnected.

Therefore, as shown in FIG. 6, due to the interconnection between two layers of TDNNs with an interval of 0, TDNN1 to TDNN10 of the delay neural network layer are sequentially interconnected. Due to the interconnection between two layers of TDNNs with an interval of 1, TDNN1 and TDNN3 of the delay neural network layer are interconnected, TDNN3 and TDNN5 are interconnected, TDNN5 and TDNN7 are interconnected, TDNN7 and TDNN9 are interconnected, TDNN2 and TONN4 are interconnected, TDNN4 and TDNN6 are interconnected, TDNN6 and TDNN7 are interconnected, and TDNN8 and TONN10 are interconnected. Due to the interconnection between two layers of TDNNs with an interval of 3, TDNN 1 and TDNN5 of the delay neural network layer are interconnected, TDNN2 and TDNN7 are interconnected, TDNN3 and TDNN8 are interconnected, TDNN4 and TDNN9 are interconnected, and TDNN5 and TDNN10 are interconnected.

By connecting two layers of TDNNs with an interval of 0 or 1 or 3 among the ten layers of TDNNs in the delay neural network layer, the last layer of TDNN (TDNN10) can fully consider the feature variability of about ten frames in the audio. Since a phoneme usually spans ten frames, the use of the delay neural network layer structure shown in FIG. 7 can maximize the consistency with the characteristics of phoneme modeling and obtain more accurate phoneme modeling information.

In S13, time information of the text unit is determined based on a playback duration of the audio frame.

Optionally, the time information of the text unit comprises a start time and a duration of the text unit.

Optionally, the determining the time information of the text unit based on the playback duration of the audio frame comprises:
obtaining time information of the various phonemes in the phoneme propagation sequence based on the playback durations of the audio frames and the matching relationship between the various phonemes in the phoneme propagation sequence and the audio features; and
determining the time information of the text unit based on the time information of the various phonemes in the phoneme propagation sequence and the phonemes corresponding to the text units.

Specifically, phoneme combinations can be translated into the text unit based on the pronunciation lexicon, and the time information of the phoneme can be integrated into the start time and the duration of the text unit. Then, the lyric file of the song can be generated based on the text units and the start times and durations of the text units in the lyric text.

As an illustration, if a certain phoneme matches with audio features of audio frames 101 to 110, and a playback duration of an audio frame is 25 ms, a start time of this phoneme is 2.5 s, i.e., a start time of audio frame 101, and a duration of the phoneme is 10*25 ms=0.25 s.

In S14, a lyric file is generated for the song based on the time information of the text unit.

The lyric file is used to, when the song is played to a location indicated by the time information, indicate a display of the text unit.

It should be noted that the lyric file mentioned in this disclosure is a complete lyric file with precise time point information, which may be in a Kugou ResourCe (KRC) or LRC (Lyric which is a lyric file extension) format.

The lyric file generation method provided in the disclosed embodiment first obtains the phoneme propagation sequence of the song and the audio frame sequence of the song, then determines the audio frame corresponding to the text unit in the audio frame sequence, determines the time information of the text unit based on the playback duration of the audio frame and the audio frame corresponding to the text unit, and finally generates the lyric file of the song based on the time information of the text unit, wherein the lyric file is used to, when the song is played to a location indicated by the time information, indicate a display of the text unit. That is, the embodiment of the present disclosure provides a method for automatically generating a lyric file for a song. Compared to the method of manually generating lyric files, the lyric file generation method provided in the embodiment of the present disclosure can automatically generate a lyric file for a song. Therefore, the embodiment of the present disclosure can improve an efficiency of lyric file generation and solve the problem of low efficiency of lyric file generation in the prior art.

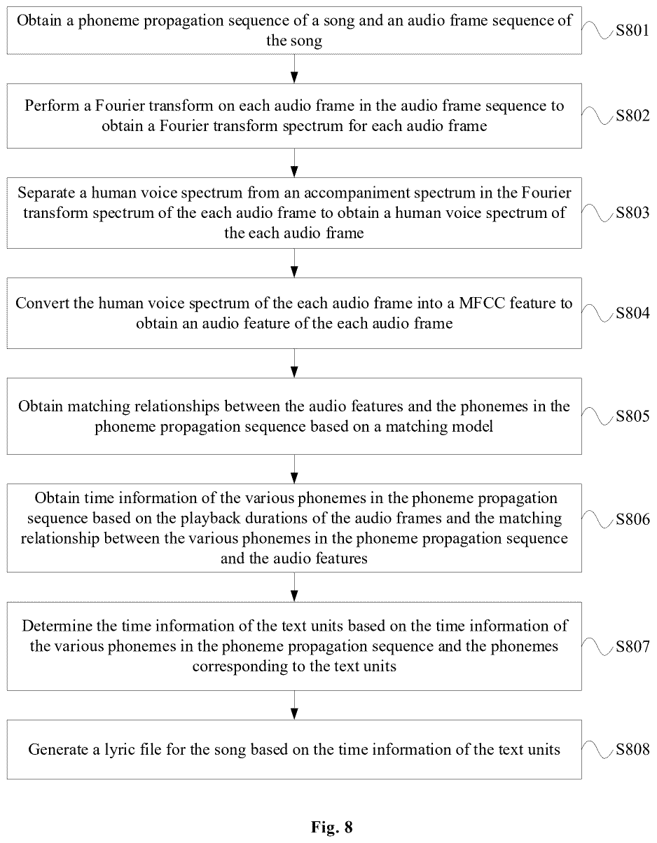

As an extension and refinement of the lyric file generation method provided in the above embodiment of the present disclosure, another lyric file generation method is also provided in an embodiment of this disclosure. As shown in FIG. 8, the lyric file generation method comprises steps S801 to S808.

In S801, a phoneme propagation sequence of a song and an audio frame sequence of the song are obtained.

The phoneme propagation sequence comprises phonemes corresponding to text units in the lyric text of the song.

In S802, a Fourier transform is performed on each audio frame in the audio frame sequence to obtain a Fourier transform spectrum for each audio frame.

Specifically, the Fourier transform spectrum may be a Fourier transform spectrogram.

In S803, a human voice spectrum is separated from an accompaniment spectrum in the Fourier transform spectrum of the each audio frame to obtain a human voice spectrum of the each audio frame.

In S804, the human voice spectrum of the each audio frame is converted into a Mel Frequency Cepstrum Coefficient (MFCC) feature to obtain an audio feature of the each audio frame.

In S805, matching relationships between the audio features and the phonemes in the phoneme propagation sequence are obtained based on a matching model.

In S806, time information of the various phonemes in the phoneme propagation sequence is obtained based on the playback durations of the audio frames and the matching relationship between the various phonemes in the phoneme propagation sequence and the audio features.

In S807, the time information of the text units is determined based on the time information of the various phonemes in the phoneme propagation sequence and the phonemes corresponding to the text units.

Specifically, the time information of the phonemes comprises a start time and a duration of each phoneme; the time information of a text unit comprises a start time and a duration of the text unit. The start time of any text unit is the start time of the first phoneme of the phonemes corresponding to the text unit, and the duration of any text unit is the sum of the durations of all the phonemes corresponding to that text unit. For example, if a text unit in a lyric text contains two phonemes, the first phoneme having a start time t1 and a duration T1, the second phoneme having a start t2 and a duration T2, the time information of the text unit can be determined as follows: start time: t1 and duration: T1+T2.

In S808, a lyric file is generated for the song based on the time information of the text units.

As an extension and refinement of the lyric file generation method shown in FIG. 1, the principle and technical effect of the lyric file generation method provided in the above embodiment is similar to that of the method shown in FIG. 1, and will not be repeated here.

As an optional embodiment of the present disclosure, the matching model comprises matching models corresponding to various genres.

Specifically, in model training, training samples can first be classified based on their respective genres, and those with the same genre can be grouped into a same training sample group. Then, a neural network model can be trained based on training sample groups corresponding to various genres to obtain matching models corresponding to different genres. Finally, the matching models corresponding to different genres can be fused to obtain the matching model. Thus, the matching model comprises matching models that correspond to various genres, respectively.

It should be noted that the matching models corresponding to various genres can be independent of each other or fused into a comprehensive matching model. A genre and a corresponding model can be determined in the comprehensive model.

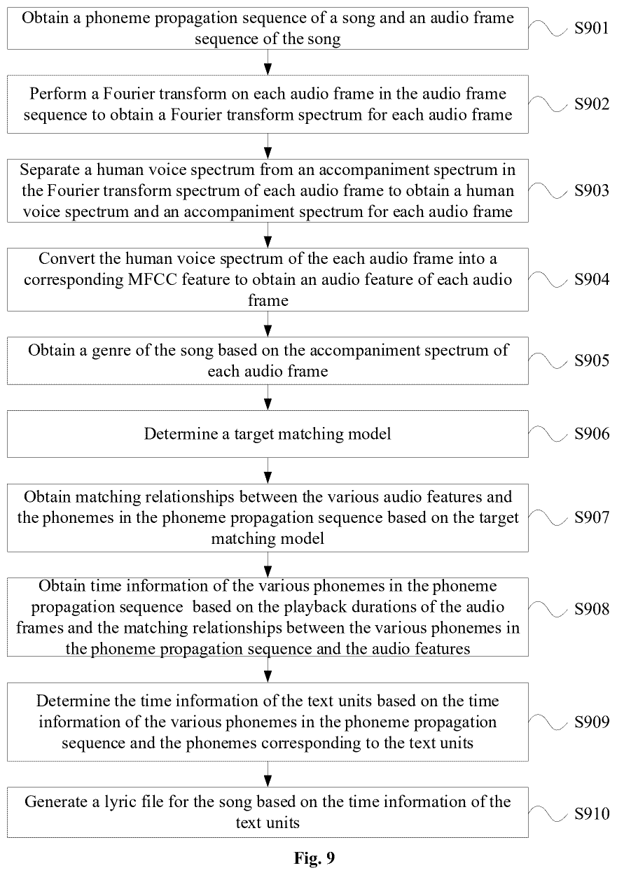

On a basis that the matching model comprises matching models corresponding to various genres, as an extension and refinement of the lyric file generation method provided in the above embodiment, another lyric file generation method is also provided in an embodiment of this disclosure. As shown in FIG. 9, the lyric file generation method comprises steps S901 to S910.

In S901, a phoneme propagation sequence of a song and an audio frame sequence of the song are obtained.

The phoneme propagation sequence comprises phonemes corresponding to text units in the lyric text of the song.

In S902, a Fourier transform is performed on each audio frame in the audio frame sequence to obtain a Fourier transform spectrum for each audio frame.

In S903, a human voice spectrum is separated from an accompaniment spectrum in the Fourier transform spectrum of each audio frame to obtain a human voice spectrum and an accompaniment spectrum for each audio frame.

In S904, the human voice spectrum of the each audio frame is converted into a corresponding MFCC feature to obtain an audio feature of each audio frame.

In S905, a genre of the song is obtained based on the accompaniment spectrum of each audio frame.

It should be noted that in this disclosed embodiment, an order of S904 and S905 is not limited. The audio feature of each audio frame can be obtained before obtaining the genre of the song and vice versa, or the audio features of each audio frame and the genre of the song can be obtained simultaneously.

In S906, a target matching model is determined.

The target matching model is a matching model corresponding to the genre of the song.

In S907, matching relationships between the various audio features and the phonemes in the phoneme propagation sequence are obtained based on the target matching model.

Specifically, the process of steps S906 and S907 may be as follows: inputting the song genre, the audio features of each audio frame in the audio frame sequence, and the phoneme propagation sequence into the matching model to determine a target matching model, and then obtaining the matching relationships between the audio features and the phonemes in the phoneme propagation sequence based on the target matching model.

In S908, time information of the various phonemes in the phoneme propagation sequence is obtained based on the playback durations of the audio frames and the matching relationships between the various phonemes in the phoneme propagation sequence and the audio features.

In S909, the time information of the text units determined based on the time information of the various phonemes in the phoneme propagation sequence and the phonemes corresponding to the text units.

In S910, a lyric file is generated for the song based on the time information of the text units.

Since the matching model comprises matching models corresponding to various genres, when obtaining the matching relationships between the audio features and the phonemes in the phoneme propagation sequence, first the accompaniment spectrum of the each audio frame is obtained, and then the genre of the song is obtained based on the accompaniment spectrum of the each audio frame; the target matching model corresponding to the genre of the song is then obtained from the matching model based on the genre of the song, and finally, based on the target matching model, the matching relationships between the audio features and the phonemes in the phoneme propagation sequence are obtained, therefore the above embodiment can maximize the utilization of the characteristics of different genres, and thus improving the accuracy of the output of the matching model.

As an optional embodiment of the present disclosure, based on the above embodiments, the lyric file generation method provided by the present disclosure further comprises:
obtaining a confidence sequence, wherein various confidence scores in the confidence sequence are used to represent matching degrees between the audio features and the phonemes;
determining whether the matching degrees between the phonemes and the audio features corresponding to the text unit are all less than a preset threshold based on the confidence sequence;
in a case where the matching degrees of the phonemes and the audio features corresponding to the text unit are all less than the preset threshold value, adjusting the start times of all the text units after the text unit in the lyrics text forward by a preset time length.

The principle of the above embodiment is as follows. If the matching degrees of the phonemes corresponding to a certain text unit are all less than the preset threshold, it can be determined that for the text unit present in the lyric text, there are no audio features corresponding to that text unit. The reason for this problem may be a redundant character in the lyric text, a character the sound of which is missed in the singing process, etc. In order to ensure an accuracy of time information of the other text units in the lyric text, start times of all text units after this text unit in the lyric text can be shifted forward by a preset time length required for a character.

Optionally, the method of obtaining the confidence sequence may comprise obtaining the matching degrees between the audio features and the phonemes in the phoneme propagation sequence output by the matching model, while obtaining the matching relationships between the audio features and the phonemes in the phoneme propagation sequence based on the matching model.

Optional, the preset threshold may be 0.2 s and the preset time length is 0.3 s. That is, if the matching degrees of the phonemes of a text unit are all less than 0.2, the start times of all text units after that text unit in the lyrics text will be shifted forward by 0.3 s. For example, if a start time of a first text unit is t3, and if matching degrees of the phonemes corresponding to a second text unit in the lyric text are all less than 0.2, and the second text unit is located before the first text unit, the start time of the first text unit will be adjusted to t3-0.3 s.

Based on the same inventive concept, as an implementation of the above method, a lyric file generation apparatus is further provided in an embodiment of the present disclosure. The embodiment of the lyric file generation apparatus corresponds to the above method embodiment. For ease of reading, the contents of the above method embodiment will not be explained in detail in this apparatus embodiment, but it should be clarified that the lyric file generation apparatus in this embodiment can correspond to all the contents in the above method embodiment.

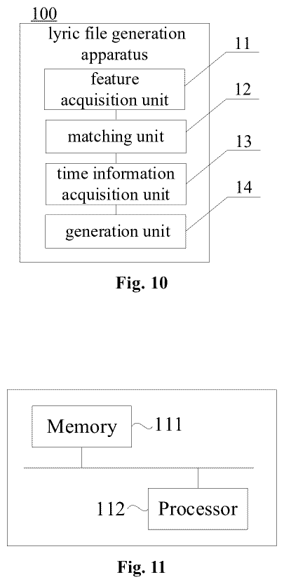

FIG. 10 is a schematic diagram of the structure of a lyric file generation apparatus provided in an embodiment of the present disclosure. As shown in FIG. 10. The lyric file generation apparatus 100 provided in this embodiment comprises:
a feature acquisition unit 11 for obtaining a phoneme propagation sequence of a song and an audio frame sequence of the song, the phoneme propagation sequence comprising a phoneme corresponding to a text unit in a lyric text of the song;
a matching unit 12 for determining an audio frame corresponding to the text unit in the audio frame sequence, wherein the phoneme corresponding to the text unit matches with an audio feature of the audio frame;
a time information acquisition unit 13 for determining time information of the text unit based on a playback duration of the audio frame; and
a generation unit 14 for generating a lyric file of the song based on the time information of the text unit, wherein the lyric file is used to indicate a display of the text unit when the song is played to a location indicated by the time information.

As an optional embodiment of the present disclosure, the feature acquisition unit 11 is specifically used for obtaining a phoneme set corresponding to the text unit based on a pronunciation lexicon, wherein the pronunciation lexicon comprises a correspondence between the text unit and the phoneme set, and the phoneme set corresponding to the text unit is a set of phoneme(s) corresponding to pronunciation(s) of the text unit; obtaining the phoneme corresponding to the text unit from the phoneme set corresponding to the text unit based on a pronunciation of the text unit in the song; and generating the phoneme propagation sequence based on the phoneme corresponding to the text unit.

As an optional embodiment of the present disclosure, the feature acquisition unit 11 is specifically used for obtaining a phoneme set corresponding to the text unit based on a pronunciation lexicon, wherein the pronunciation lexicon comprises a correspondence between the text unit and the phoneme set, the phoneme set corresponding to the text unit being a set composed of phoneme subset(s) corresponding to pronunciation(s) of the text unit, and a phoneme subset corresponding to any of the pronunciation(s) being a set comprising permutation and combinations of various pronunciation durations of the phoneme(s) corresponding to the pronunciation; obtaining a target phoneme subset of the text unit from the phoneme set corresponding to the text unit based on a pronunciation of the text unit in the song; obtaining the phoneme corresponding to the text unit from the target phoneme subset of the text unit based on a pronunciation duration of the text unit in the song; and generating the phoneme propagation sequence based on the phoneme corresponding to the text unit.

As an optional embodiment of the present disclosure, the feature acquisition unit 11 is specifically used for obtaining a phoneme set corresponding to the text unit based on a pronunciation lexicon, wherein the pronunciation lexicon comprises a correspondence between the text unit and the phoneme set, the phoneme set corresponding to the text unit being a set composed of phoneme subset(s) corresponding to pronunciation(s) of the text unit, and a phoneme subset corresponding to any of the pronunciation(s) being a set comprising permutation and combination of various phoneme(s) and various phoneme(s) with transposition phoneme corresponding to the pronunciation; obtaining a target phoneme subset of the text unit from the phoneme set corresponding to the text unit based on a pronunciation thereof in the song; obtaining the phoneme corresponding to the text unit from the target phoneme subset of the text unit based on a tone conversion of the text unit in the song; and generating the phoneme propagation sequence based on the phoneme corresponding to the text unit.

As an optional embodiment of the present disclosure, the feature acquisition unit 11 is specifically used for sampling audio signals of the song based on a preset sampling frequency and a preset format to obtain a sampling sequence of the song; and generating the audio frame sequence of the song based on a duration of the audio frame and the sampling sequence.

As an optional embodiment of the present disclosure,
the preset sampling frequency is 16 kHz; and
the preset format is a 16-bit mono Wave Pulse Code Modulation (PCM) format.

As an optional embodiment of the present disclosure, the matching unit 12 is specifically used for performing a Fourier transform on each audio frame in the audio frame sequence to obtain a Fourier transform spectrum for the each audio frame before determining the audio frames corresponding to the text units in the audio frame sequence; separating a human voice spectrum from an accompaniment spectrum in the Fourier transform spectrum of the each audio frame to obtain a human voice spectrum of the each audio frame; and converting the human voice spectrum of the each audio frame into a MFCC feature to obtain an audio feature of the each audio frame.

As an optional embodiment of the present disclosure, the matching unit 12 is further used for performing a Fourier transform on each audio frame in the audio frame sequence to obtain a Fourier transform spectrum for the each audio frame; separating a human voice spectrum and an accompaniment spectrum in the Fourier transform spectrum of the each audio frame to obtain the accompaniment spectrum of the each audio frame; obtaining a genre of the song based on the accompaniment spectrum of the each audio frame; obtaining a target matching model, the target matching model being a matching model corresponding to the genre of the song; and obtaining the matching relationships between the various audio features and the phonemes in the phoneme propagation sequence based on the target matching model.

As an optional embodiment of the present disclosure, the time information acquisition unit 13 is used for obtaining time information of the various phonemes in the phoneme propagation sequence based on playback durations of the audio frames and the matching relationships between the various phonemes in the phoneme propagation sequence and the audio features; and determining the time information of the text unit based on the time information of the various phonemes in the phoneme propagation sequence and the phoneme corresponding to the text unit.

As an optional embodiment of the present disclosure, the time information of each phoneme of the phonemes in the phoneme propagation sequence comprises a start time and a duration of the each phoneme; and
the time information of the text unit comprises a start time and a duration of the text unit.

As an optional embodiment of the present disclosure, the generation unit 14 is further used for obtaining a confidence sequence, wherein various confidence scores in the confidence sequence are used to represent matching degrees between the audio features and the phonemes; determining whether the matching degrees between the phonemes and the audio features corresponding to the text unit are all less than a preset threshold based on the confidence sequence; and in a case where the matching degrees of the phonemes and the audio features corresponding to a text unit are all less than the preset threshold value, adjusting the start times of all the text units after the text unit in the lyrics text forward by a preset time length.

As an optional embodiment of the present disclosure, the preset time length is 0.3 seconds.

As an optional embodiment of the present disclosure, the neural network model comprises a preprocessing layer, a convolution layer, a time delay neural network (TDNN) layer, and a classification output layer in sequence; the preprocessing layer comprises a Fully Connected Layer for upsampling the audio features in the training samples; the convolution layer comprises two layers of convolution neural networks (CNN), each of which comprises: a sub-convolution layer, an activation layer and a batch normalization (BN) layer; the TDNN layer comprises ten layers of TDNN; and the classification output layer comprises: a BN layer and a Fully Connected Layer for matching an output result of the TDNN layer with various phonemes in a phoneme propagation sequence in the training samples after downsampling the output result.

As an optional embodiment of the present disclosure, among the ten layers of TDNN in the TDNN layer, two layers of TDNN with an interval of 0 or 1 or 3 are interconnected.

The lyric file generation apparatus provided in this embodiment can perform the lyric file generation method provided in the above method embodiment, and its principle and technical effect are similar to that of the method embodiment, which will not be repeated here.

Based on the same inventive concept, an embodiment of the present disclosure further provides an electronic device. FIG. 11 is a schematic diagram showing the structure of the electronic device provided in an embodiment of the present disclosure. As shown in FIG. 11. The electronic device provided in this embodiment comprises: a memory 111 for storing computer programs; a processor 112 for performing, by invoking the computer programs, the steps of the lyric file generation method provided in the above method embodiment.

Specifically, the memory 111 may be used to store software programs and various data. The memory 111 may mainly comprise a program storage area and a data storage area, wherein the program storage area may store an operating system and applications required for at least one function (such as sound playback function, image playback function, etc.); the data storage area may store data created by using the mobile phone (such as audio data, phone book, etc.). The memory 111 may comprises high speed random access memory, or may comprise non-volatile memory, such as at least one magnetic storage device, a flash memory device or other non-volatile solid-state storage device.

The processor 112 is a control center of the electronic device, which utilizes various interfaces and wires to connect various parts of the electronic device. By running or executing the software program and/or modules stored in the memory, and by invoking data stored in the memory 111, the various functions and data processing functions may be executed, thus integrally monitoring the electronic device. The processor 112 may comprise one or more processing units.

In addition, it can be understood that the electronic device provided by the embodiment of the present disclosure may further comprise: components such as a Radio Frequency (RF) unit, a network module, an audio output unit, sensors, a signal receiving unit, a display, a user receiving unit, an interface unit, and a power source. Those skilled in the art can understand that the structure of the electronic device described above does not constitute a limitation on the electronic device. The electronic device may comprise more or fewer components, or combine some components, or have different component arrangements. In the embodiment of the present disclosure, the electronic device comprises, but is not limited to, mobile phones, tablets, laptops, PDAs, vehicle terminals, wearable devices, pedometers, etc.

The RF unit can be used for sending and receiving information or receiving and sending signals during a call, specifically, after receiving downlink information from a base station, sending it to the processor 112 for processing; in addition, the RF unit can be used for sending uplink data to the base station. Generally, the RF unit comprises, but is not limited to, an antenna, at least one amplifier, a transceiver, a coupler, a low noise amplifier, a duplexer, and the like. In addition, the RF unit can also communicate with a network and other devices through wireless communication systems.

The electronic device provide users with wireless broadband Internet access through network modules, to help them send and receive emails, browse web pages, or access streaming media.

The audio output unit can convert audio data received by the RF unit or network module or stored in the memory 111 into audio signals and output them as sound. Moreover, the audio output unit may also provide audio outputs related to specific functions performed by the electronic device (such as, sounds that play when call signals or messages are received, etc.). The audio output unit comprises a speaker, a buzzer, and a receiver, etc.

The signal receiving unit is used to receive audio or video signals. The receiving unit may comprise a microphone and a graphics processing unit (GPU) that processes the image data of static images or videos acquired by image capture devices (such as cameras) in video capture mode or image capture mode. The processed image frames can be displayed on the display unit. The image frames processed by the GPU can be stored in memory (or other storage media) or sent via the radio frequency unit or network module. The microphone can receive sound and process it into audio data. The processed audio data can be converted into a format that can be sent via the RF unit to a mobile communication base station for output in call mode.

The electronic device also comprises at least one sensor, such as light sensors, motion sensors, and other sensors. Specifically, the light sensors comprise an ambient light sensor and a proximity sensor, wherein the ambient light sensor can adjust the brightness of the display panel based on the brightness of the ambient light, and the proximity sensor can turn off the display panel and/or backlight when the electronic device is moved to ears of the user. As a type of motion sensor, acceleration sensors can detect the magnitude of acceleration in different directions (usually in three axes), and can detect the magnitude and direction of gravity when the device is static. Acceleration sensors can be used to identify the posture of the electronic device (e.g., in landscape/portrait mode switching, in related games, or in magnetometer posture calibration), and can be used in vibration detection-related functions (e.g., a pedometer or a knocking), and the like; the sensors can also comprise fingerprint sensors, pressure sensors, iris sensors, molecular sensors, gyroscopes, barometers, hygrometers, thermometers, infrared sensors, etc., which are not described in detail here.

The display unit is used to display information input by the user or provided to the user. The display unit can comprise a display panel configured as a liquid crystal display (LCD), an organic light-emitting diode (OLED) and the like.

The user receiving unit can be used to receive figure or character information inputted and generate a key signal input related to a user setup or function control of the electronic device. In detail, the user input unit may comprise a touch panel and other input devices. The touch panel (also called as touch screen) may be configured to gather touch operations near or on the touch panel (such as an operation on the touch panel or near the touch panel of the user with a finger, a stylus or other suitable objects or attachments). The touch panel may comprise a touch detection device and a touch controller. The touch detection device detects an orientation of the user's touch, detects a signal caused by the touch operation and sends the signal to the touch controller. The touch controller receives the touch information on the touch detection device, converts the touch information to touch point coordinates, and sends the touch point coordinates to the processor 112. Furthermore, the touch controller may receive and execute a command sent from the processor 112. The touch panel may be implemented as resistance typed, capacitive typed, infrared typed and surface acoustic wave typed. In addition to the touch panel, the user input unit may further comprise other input devices. In detail, the other input devices may comprise, but are not limited to, physical keyboards, function keys (such as volume control keys, switch keys, etc.), trackball, mice, and joysticks, which will not be described in detail here.

Further, the touch panel may be covered on the display panel; when the touch panel detects a touch operation on or in proximity to it, the touch operation is transmitted to the processor 112 to determine the type of the touch event, the processor 112 then provides corresponding visual output on the display panel according to the type of touch event. Although the touch panel and the display panel are generally two separate components to realize an input and output function of the electronic device, in certain embodiments, the touch panel and the display panel may be integrated to realize the input and output function of the electronic device, which is not limited in this disclosure.

The interface unit is an interface for connecting an external device and the electronic device. For example, the external device may comprise a wired or wireless headset port, an external power source (or battery charger) port, a wired or wireless data port, a memory card port, a port for connecting a device with an identification module, an audio input/output (I/O) port, a video I/O port, a headphone port, and so on. The interface unit can be used to receive input from an external device (for example, data information, power, etc.) and transmit the received input to one or more elements in the electronic device, or can be used to transmit data between the electronic device and the external device.

The electronic device may also comprise a power source (such as a battery) for supplying power to various components. Optionally, the power source may be logically connected to the processor 112 through a power management system, so that functions such as charging and discharging management, and power consumption management can be realized by the power management system.

An embodiment of the present disclosure further provides a non-transitory computer readable storage medium storing thereon a computer program that, when executed by a processor, implement the lyric file generation method described in the above method embodiment.

One skilled in the art should understand that, the embodiments of the present disclosure may be provided as a method, a system, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable storage media having computer-usable program code embodied therein.

The computer-readable media comprise permanent and non-permanent, removable and non-removable storage media. The storage medium can realize information storage by any method or technology. The information can be computer-readable instructions, data structures, program modules, or other data. Examples of computer storage media comprise, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, CD-ROM, digital versatile disc (DVD) or other optical storage, magnetic cassettes, magnetic tape, magnetic disk storage or other magnetic storage devices, or any other non-transmission media that can be used to store information that can be accessed by computing devices. According to the definition herein, computer-readable media does not comprise transitory media, such as modulated data signals and carrier waves.

It should be noted that terms “comprise”, “comprise” or their any other variations used in this description are intended to encompass non-exclusive composition, so that a process, method, product or device comprising a series of factors may comprise not only these factors, but also other factors that are not listed explicitly, or factors intrinsic to this process, method, product or device. Without limitation, a factor defined by wording “comprise one . . . ” does not exclude the existence of other same factors in a process, method, product or device comprising such factor.

The above descriptions are only specific embodiments of the present disclosure, SO that those skilled in the art can understand or implement the present disclosure. Various modifications to these embodiments will be apparent to those skilled in the art, and the generic principles defined herein may be implemented in other embodiments without departing from the spirit or scope of the present disclosure. Accordingly, the present disclosure should not be limited to the specific embodiments described herein, but should be accorded the broadest scope consistent with the principles and novel features disclosed herein.

1. A lyric file generation method, comprising:
obtaining a phoneme propagation sequence of a song and an audio frame sequence of the song, the phoneme propagation sequence comprising a phoneme corresponding to a text unit in a lyric text of the song;
determining an audio frame corresponding to the text unit in the audio frame sequence, wherein the phoneme corresponding to the text unit matches with an audio feature of the audio frame;
determining time information of the text unit based on playback duration of the audio frame; and
generating a lyric file of the song based on the time information of the text unit, wherein the lyric file is used to indicate a display of the text unit when the song is played to a location indicated by the time information.

2. The lyric file generation method according to claim 1, wherein the obtaining the phoneme propagation sequence of the song comprises:
obtaining a phoneme set corresponding to the text unit based on a pronunciation lexicon, wherein the pronunciation lexicon comprises a correspondence between the text unit and the phoneme set, and the phoneme set corresponding to the text unit is a set of phoneme(s) corresponding to pronunciation(s) of the text unit;
obtaining the phoneme corresponding to the text unit from the phoneme set corresponding to the text unit based on a pronunciation of the text unit in the song; and
generating the phoneme propagation sequence based on the phoneme corresponding to the text unit.

3. The lyric file generation method according to claim 1, wherein the obtaining the phoneme propagation sequence of the song comprises:
obtaining a phoneme set corresponding to the text unit based on a pronunciation lexicon, wherein the pronunciation lexicon comprises a correspondence between the text unit and the phoneme set, the phoneme set corresponding to the text unit being a set composed of phoneme subset(s) corresponding to pronunciation(s) of the text unit, and a phoneme subset corresponding to any of the pronunciation(s) being a set comprising permutation and combinations of various pronunciation durations of the phoneme(s) corresponding to the pronunciation;
obtaining a target phoneme subset of the text unit from the phoneme set corresponding to the text unit based on a pronunciation of the text unit in the song;
obtaining the phoneme corresponding to the text unit from the target phoneme subset of the text unit based on a pronunciation duration of the text unit in the song; and
generating the phoneme propagation sequence based on the phoneme corresponding to the text unit.

4. The lyric file generation method according to claim 1, wherein the obtaining the phoneme propagation sequence of the song comprises:
obtaining a phoneme set corresponding to the text unit based on a pronunciation lexicon, wherein the pronunciation lexicon comprises a correspondence between the text unit and the phoneme set, the phoneme set corresponding to the text unit being a set composed of phoneme subset(s) corresponding to pronunciation(s) of the text unit, and a phoneme subset corresponding to any of the pronunciation(s) being a set comprising permutation and combination of various phoneme(s) and various phoneme(s) with transposition phoneme corresponding to the pronunciation;
obtaining a target phoneme subset of the text unit from the phoneme set corresponding to the text unit based on a pronunciation thereof in the song;
obtaining the phoneme corresponding to the text unit from the target phoneme subset of the text unit based on a tone conversion of the text unit in the song; and
generating the phoneme propagation sequence based on the phoneme corresponding to the text unit.

5. The lyric file generation method according to claim 1, wherein the obtaining the audio frame sequence of the song comprises:
sampling audio signals of the song based on a preset sampling frequency and a preset format to obtain a sampling sequence of the song; and
generating the audio frame sequence of the song based on a duration of the audio frame and the sampling sequence.

6. The lyric file generation method according to claim 5, wherein:
the preset sampling frequency is 16 kHz; and
the preset format is a 16-bit mono Wave Pulse Code Modulation (PCM) format.

7. The lyric file generation method according to claim 1, further comprising:
performing a Fourier transform on each audio frame in the audio frame sequence to obtain a Fourier transform spectrum for the each audio frame before determining the audio frames corresponding to the text units in the audio frame sequence;
separating a human voice spectrum from an accompaniment spectrum in the Fourier transform spectrum of the each audio frame to obtain a human voice spectrum of the each audio frame; and
converting the human voice spectrum of the each audio frame into a Mel Frequency Cepstrum Coefficient (MFCC) feature to obtain an audio feature of the each audio frame.

8. The lyric file generation method according to claim 1, wherein the determining the audio frame corresponding to the text unit in the audio frame sequence comprises:
obtaining matching relationships between audio features and phonemes in the phoneme propagation sequence based on a matching model, wherein the matching model is a model obtained by training a neural network model based on training samples comprising matched audio features and phonemes; and
determining the audio frame corresponding to the text unit in the audio frame sequence based on the matching relationships between various audio features and phonemes in the phoneme propagation sequence, as well as the phoneme corresponding to the text unit.

9. The lyric file generation method according to claim 8, wherein the obtaining the matching relationships between the various audio features and the phonemes in the phoneme propagation sequence based on the matching model comprises:
performing a Fourier transform on each audio frame in the audio frame sequence to obtain a Fourier transform spectrum for the each audio frame;
separating a human voice spectrum and an accompaniment spectrum in the Fourier transform spectrum of the each audio frame to obtain the accompaniment spectrum of the each audio frame;
obtaining a genre of the song based on the accompaniment spectrum of the each audio frame;
obtaining a target matching model, the target matching model being a matching model corresponding to the genre of the song; and
obtaining the matching relationships between the various audio features and the phonemes in the phoneme propagation sequence based on the target matching model.

10. The lyric file generation method according to claim 8, wherein the determining the time information of the text unit based on the playback duration of the audio frame comprises:
obtaining time information of the various phonemes in the phoneme propagation sequence based on playback durations of the audio frames and the matching relationships between the various phonemes in the phoneme propagation sequence and the audio features; and
determining the time information of the text unit based on the time information of the various phonemes in the phoneme propagation sequence and the phoneme corresponding to the text unit.

11. The lyric file generation method according to claim 10, wherein:
the time information of each phoneme of the phonemes in the phoneme propagation sequence comprises a start time and a duration of the each phoneme; and
the time information of the text unit comprises a start time and a duration of the text unit.

12. The lyric file generation method according to claim 8, further comprising:
obtaining a confidence sequence, wherein various confidence scores in the confidence sequence are used to represent matching degrees between the audio features and the phonemes;
determining whether the matching degrees between the phonemes and the audio features corresponding to the text unit are all less than a preset threshold based on the confidence sequence; and
in a case where the matching degrees of the phonemes and the audio features corresponding to a text unit are all less than the preset threshold value, adjusting the start times of all the text units after the text unit in the lyrics text forward by a preset time length.

13. The lyric file generation method according to claim 12, wherein the preset time length is 0.3 seconds.

14. The lyric file generation method according to claim 8, wherein:
the neural network model comprises a preprocessing layer, a convolution layer, a time delay neural network (TDNN) layer, and a classification output layer in sequence;
the preprocessing layer comprises a Fully Connected Layer for upsampling the audio features in the training samples;
the convolution layer comprises two layers of convolution neural networks (CNN), each of which comprises: a sub-convolution layer, an activation layer and a batch normalization (BN) layer;
the TDNN layer comprises ten layers of TDNN; and
the classification output layer comprises: a BN layer and a Fully Connected Layer for matching an output result of the TDNN layer with various phonemes in a phoneme propagation sequence in the training samples after downsampling the output result.

15. The lyric file generation method according to claim 14, wherein among the ten layers of TDNN in the TDNN layer, two layers of TDNN with an interval of 0 or 1 or 3 are interconnected.

16. (canceled)

17. An electronic device, comprising:
a memory for storing computer programs;
a processor for performing, by invoking the computer programs, the lyric file generation method comprising:
obtaining a phoneme propagation sequence of a song and an audio frame sequence of the song, the phoneme propagation sequence comprising a phoneme corresponding to a text unit in a lyric text of the song;
determining an audio frame corresponding to the text unit in the audio frame sequence, wherein the phoneme corresponding to the text unit matches with an audio feature of the audio frame;
determining time information of the text unit based on playback duration of the audio frame; and
generating a lyric file of the song based on the time information of the text unit, wherein the lyric file is used to indicate a display of the text unit when the song is played to a location indicated by the time information.

18. A non-transitory computer-readable storage medium stored thereon a computer program that, when executed by a processor, implements the lyric file generation method comprising:
obtaining a phoneme propagation sequence of a song and an audio frame sequence of the song, the phoneme propagation sequence comprising a phoneme corresponding to a text unit in a lyric text of the song;
determining an audio frame corresponding to the text unit in the audio frame sequence, wherein the phoneme corresponding to the text unit matches with an audio feature of the audio frame;
determining time information of the text unit based on playback duration of the audio frame; and
generating a lyric file of the song based on the time information of the text unit, wherein the lyric file is used to indicate a display of the text unit when the song is played to a location indicated by the time information.

19. (canceled)

20. (canceled)

21. The electronic device according to claim 17, wherein the processor is configured to:
obtaining a phoneme set corresponding to the text unit based on a pronunciation lexicon, wherein the pronunciation lexicon comprises a correspondence between the text unit and the phoneme set, and the phoneme set corresponding to the text unit is a set of phoneme(s) corresponding to pronunciation(s) of the text unit;
obtaining the phoneme corresponding to the text unit from the phoneme set corresponding to the text unit based on a pronunciation of the text unit in the song; and
generating the phoneme propagation sequence based on the phoneme corresponding to the text unit.

22. The electronic device according to claim 17, wherein the processor is configured to:
obtaining a phoneme set corresponding to the text unit based on a pronunciation lexicon, wherein the pronunciation lexicon comprises a correspondence between the text unit and the phoneme set, the phoneme set corresponding to the text unit being a set composed of phoneme subset(s) corresponding to pronunciation(s) of the text unit, and a phoneme subset corresponding to any of the pronunciation(s) being a set comprising permutation and combinations of various pronunciation durations of the phoneme(s) corresponding to the pronunciation;
obtaining a target phoneme subset of the text unit from the phoneme set corresponding to the text unit based on a pronunciation of the text unit in the song;
obtaining the phoneme corresponding to the text unit from the target phoneme subset of the text unit based on a pronunciation duration of the text unit in the song; and
generating the phoneme propagation sequence based on the phoneme corresponding to the text unit.

23. The electronic device according to claim 17, wherein the processor is configured to:
obtaining a phoneme set corresponding to the text unit based on a pronunciation lexicon, wherein the pronunciation lexicon comprises a correspondence between the text unit and the phoneme set, the phoneme set corresponding to the text unit being a set composed of phoneme subset(s) corresponding to pronunciation(s) of the text unit, and a phoneme subset corresponding to any of the pronunciation(s) being a set comprising permutation and combination of various phoneme(s) and various phoneme(s) with transposition phoneme corresponding to the pronunciation;
obtaining a target phoneme subset of the text unit from the phoneme set corresponding to the text unit based on a pronunciation thereof in the song;
obtaining the phoneme corresponding to the text unit from the target phoneme subset of the text unit based on a tone conversion of the text unit in the song; and
generating the phoneme propagation sequence based on the phoneme corresponding to the text unit.
